(19) United States
(12) Patent Application Publication
(10) Pub. No.: US 2026/0150835 A1
(43) Pub. Date: Jun. 4, 2026

(54) ANTIMICROBIAL COMPOSITION

(71) Applicant: PROTECNICA INGENIERIA S.A.S., Yumbo - Valle del Cauca (CO)

(72) Inventors: Rita Esther García Pasiminio, Yumbo - Valle del Cauca (CO); Denisse Adriana Oñate Pérez, Yumbo - Valle del Cauca (CO); Guillermo Andrés Viecco Castillo, Yumbo - Valle del Cauca (CO)

(21) Appl. No.: 19/394,307

(22) Filed: Nov. 19, 2025

(30) Foreign Application Priority Data
Dec. 4, 2024 (CO) NC2024/0016702

(51) Int. Cl. A01N 31/14; A01N 31/02; A01N 37/36; A01P 1/00

(52) U.S. Cl. CPC A01N 31/14; A01N 31/02; A01N 37/36; A01P 1/00

(57) ABSTRACT

The present invention aims to provide an antimicrobial product, particularly an antimicrobial composition comprising antimicrobial active agents and solvent and preservative activity, which has antimicrobial efficacy against bacteria, fungi and yeasts at low concentrations, exhibiting broad spectrum effectiveness for gram-positive and gram-negative bacteria and high compatibility with different types of surfactants in formulations of personal hygiene, cleaning and household care products.

### FIELD OF INVENTION

The present invention relates to a safe antimicrobial product, which has antimicrobial efficacy against bacteria, fungi and yeasts at low concentrations, has a preservative action and belongs to the field of cosmetic formulations for body hygiene, grooming and household care products with an antibacterial effect.

### STATE OF THE ART

As is well known, antimicrobials are chemical substances or mixtures of substances that, at low concentrations, act against microorganisms such as bacteria, viruses, protozoa, and fungi like mold, destroying them or inhibiting their growth. Although many substances are antimicrobial, the way they work, act, or remain effective varies.

Antimicrobials are used in cleaning products, healthcare settings, and industrial environments to help eliminate harmful bacteria and prevent the spread of infections. By inhibiting the growth of unwanted microbes, antimicrobial chemicals can help prevent people from getting sick. They are used in homes, offices, industries, healthcare facilities, and other places.

The global threat from resistant microorganisms and restrictions on some molecules currently known to pose risks to humans (toxicity, endocrine disruption, carcinogenicity), ecosystems, and antibiotic resistance has led to an urgent need for new products that eliminate and prevent the growth of pathogenic microorganisms, especially.

An antimicrobial is effective against a broad spectrum of microorganisms: this includes bacteria, mold, fungi, and even viruses. An antibacterial, on the other hand, is only effective against bacteria.

Furthermore, due to the chemical nature and ionicity of hygiene and personal care products, in some cases they are incompatible, and in others they do not cover the full spectrum of activity against all microorganisms. Some antimicrobials are not broad-spectrum because they are not effective against both Gram-positive and Gram-negative bacteria, thus preventing them from claiming bactericidal activity.

Relevant prior art includes patent US2023266030, which describes antimicrobial compositions and methods for inhibiting microbial growth. More specifically, it describes an antimicrobial composition comprising an acyl lactylate and a glycol, and methods for using them to inhibit microbial growth. The antimicrobial composition can be applied to or incorporated into articles such as wipes, or into ointments, lotions, creams, balms, sprays, gels, suspensions, aerosols, foams, soaps, or similar products.

Document KR20210057501 describes a composition for inhibiting the growth of microorganisms comprising 1,2-hexanediol and glyceryl caprylate based on a synergistic effect of 1,2-hexanediol and glyceryl caprylate to effectively inhibit the growth of yeasts, bacteria or molds.

Document CA2896116 describes an antiseptic hand rub composition comprising at least 0.2% w/w isopropyl myristate, free from other myristic acid derivatives. Phenoxyethanol is preferably present in the composition at a concentration of 1% w/w or less. A glycol may also be present, such as dipropylene glycol if the composition is an ethanol-based hand rub gel, or propylene glycol if the composition is in the form of an emulsion or dispersion. Additional biocides such as triclosan and chlorhexidine gluconate may be included in this document.

The document US2007265352 describes antimicrobial compositions and active substances comprising at least one, preferably two, unbranched (linear chain) 1,2-alkanediols and preferably an additional preservative, and also products containing such mixtures in an antimicrobially effective amount. An example of an antimicrobial mixture comprises: (a) 1,2-hexanediol and 1,2-octanediol and also optionally 1,2-pentanediol and/or 1,2-decanediol and (b) one, two, or more substances selected from the group consisting of potassium sorbate, parabens, and iodopropynyl butylcarbamate (IPBC).

While prior art describes various antimicrobial compositions, there is still a need to reduce the problem of microbial resistance, which is a threat to public health, by providing compositions that comprise a novel combination of different active agents with an improved antibacterial effect at low concentrations.

In this regard, it is an objective of the present invention to provide a novel antimicrobial product that combines different active agents in formulations for body hygiene, grooming and household care products, and that has antimicrobial efficacy against bacteria, fungi and yeasts at low concentrations.

Furthermore, it is another object of the present invention to provide an antimicrobial composition that also has preservative, emollient, stabilizing and solvent activity given by the components present in the composition.

### BRIEF DESCRIPTION OF THE INVENTION

The present invention aims to provide an antimicrobial product, particularly an antimicrobial composition comprising from low to high content of active agents, which has antimicrobial efficacy against bacteria, fungi and yeasts at low concentrations, exhibiting broad spectrum effectiveness against gram-positive and gram-negative bacteria and high compatibility with different types of surfactants in formulations for personal hygiene, cleaning and household care products.

Another object of the invention is to provide a composition that, in addition to antimicrobial activity, exhibits activity as a solvent, emollient, stabilizer, and preservative agent due to the presence of the antimicrobial agents described below.

Another object of the present invention is to provide a process for obtaining the antimicrobial composition.

### DETAILED DESCRIPTION OF THE INVENTION

The present invention relates to an antimicrobial product that is effective against bacteria, fungi, and yeasts at low concentrations, is bactericidal and fungicidal after 30 seconds of contact, and has preservative activity due to the activity of its components. Furthermore, its components have low aquatic toxicity.

As used in this document, the terms “antimicrobial”/“preservative” refer to substances capable of killing or inhibiting the growth of microorganisms, including, but not limited to, bacteria and fungi.

In a preferred embodiment, the antimicrobial product specifically refers to an antimicrobial composition comprising the active agents a), b), and c) (alcohol, aliphatic alcohol, and carboxylic acid, respectively), wherein the antimicrobial activity is provided by the mixture of the active agents with antimicrobial activity. Specifically, the antimicrobial product comprises a first, a second, and a third antimicrobial agent.

In a preferred embodiment, the first antimicrobial agent referred to as component a) acts as an antimicrobial agent with additional activity as a preservative, wherein said first antimicrobial agent is selected from the group consisting of an organic compound, preferably an alcohol, wherein the alcohol is preferably selected from phenoxypropanol, 2-phenylethanol, phenoxyethanol, phenethyl alcohol, benzyl carbinol, β-hydroxyethylbenzene, benzeneethanol and combinations thereof.

In a preferred embodiment, component a) is present in an amount between 0.0001% and 70% by weight, preferably between 0.001% and 50% by weight, more preferably between 0.1% and 20% by weight, and even more preferably between 0.5% and 6% by weight.

In another preferred embodiment, component a) is present in an amount between 0.5% and 10%, preferably between 2% and 8%, more preferably between 2% and 7%.

The second antimicrobial agent referred to as component b) acts as an antimicrobial agent with additional activity as a solvent and emollient, wherein said second antimicrobial agent is selected from the group consisting of an organic compound, wherein the organic compound is selected from aliphatic alcohols, more preferably alkanediols, and wherein the alkanediols are preferably selected from 1,2-hexanediol, 1,2-pentanediol, 1,2-butanediol, 1,4-butanediol, 1,5-pentanediol, 1,6-hexanediol, and combinations thereof.

In a preferred embodiment, component b) is present in an amount between 0.5% and 60% by weight, preferably between 5% and 40% by weight, and more preferably between 15% and 35% by weight.

In another preferred embodiment, component b) is present in an amount between 15% and 35%, preferably between 15% and 30%, and more preferably between 15% and 28%.

The third antimicrobial agent, referred to as component c), acts as an antimicrobial agent with additional activity as a preservative and stabilizer, wherein said third antimicrobial agent is selected from the group consisting of a carboxylic acid, wherein the carboxylic agent is preferably selected from acetic acid, citric acid (which are organic acids derived from fermentations), lactic acid, and combinations thereof.

In a preferred embodiment, component c) is present in an amount between 10% and 80% by weight, preferably between 30% and 50% by weight, and more preferably between 15% and 75% by weight.

In another preferred embodiment, component c) is present in an amount between 15% and 75%, preferably between 30% and 75%, and more preferably between 60% and 75%.

In another preferred embodiment, components a), b) and c) may also act as preservatives, solvents, emollients and/or stabilizers within the formulation.

Another non-limiting embodiment of this application describes that the antimicrobial composition can be advantageously used in personal care compositions, and that the compositions can be either aqueous-based or non-aqueous end-user compositions. Aqueous-based and non-aqueous end-user applications include, but are not limited to, cosmetic or personal care products, toilet products, oral care products, skin care products, hair care products, cleaning and household products, soap and bath products, industrial and institutional cleaning products, disinfectant products, wound care products, sanitary products, agricultural compositions, textile products, coating products, and laundry products.

According to another non-limiting embodiment of this application, personal care compositions include, but are not limited to, sun care compositions, after-sun compositions, hair care compositions, conditioning compositions, skin care compositions, oral care compositions, face care compositions, lip care compositions, body care compositions, nail care compositions, anti-aging compositions, deodorant compositions, color cosmetic compositions, color-protecting compositions, self-tanning compositions, and foot care compositions.

The antimicrobial composition of the present application is useful for inhibiting or killing Staphylococcus aureus, Staphylococcus epidermidis, Streptococcus pneumoniae, Streptococcus pyogenes, Enterococcus faecalis, Haemophilus influenzae, Moraxella species, Salmonella species, Campylobacter species, Pseudomonas aeruginosa, Clostridium botulinum, Clostridium perfringens, Corynebacteria species, Diplococci species, Mycobacteria species, Streptomyces species, Escherichia coli, Salmonella typhimurium, Salmonella enteritidis, Vibrio parahaemolyticus, Bacillus anthracis, Bacillus azotoformans, Bacillus cereus, Bacillus coagulans, Bacillus israelensis, Bacillus larvae, Bacillus mycoides, Bacillus polymyxa, Bacillus pumilis, Bacillus stearothormophilus, Bacillus subtilis, Bacillus thuringiensis, Bacillus validus, Bacillus weihenstephanensis, Bacillus pseudomycoides, Burkholderia cepacia, Burkholderia multivorans, Burkholderia cenocepacia, Burkholderia vietnamiensis, Burkholderia stabilis, Burkholderia ambifaria, Burkholderia dolosa, Burkholderia anthina, Burkholderia pyrrocinia, Candida tropicalis, Candida albicans, Hansenula anomala, Saccharomyces cerevisiae, Torulaspora delbreuckii, Zygosaccharomyces bailii, Zygosaccharomyces rouxii, Aspergillus niger, Aspergillus flavus, Aspergillus brasiliensis, Penicillium islandicum, Penicillium citrinum, Penicillium chrysogenum, Fusarium oxysporum, Fusarium graminearum, Fusarium solani, Alternaria alternata, and or Mucor racemosus.

According to a non-limiting embodiment of the present application, the antimicrobial composition is used to kill or inhibit the growth of Staphylococcus aureus, Escherichia coli, Burkholderia cepacia, Candida albicans, Pseudomonas aeruginosa, Aspergillus brasilensis, Salmonella typhimurium, and Enterococcus hirae.

A different embodiment of the present application provides that the antimicrobial composition of the present application may be formulated as an emulsion, microemulsion, nanoemulsion, solution, dispersion, suspension, complex coacervate, or concentrate. The antimicrobial compositions may also include various optional additives. Examples of specific additives include, but are not limited to, colorants, pigments, plasticizers, surfactants, wetting agents, fillers, coloring agents, dispersing agents, thickening agents, rheology modifiers, thixotropic agents, antifreeze agents, cosolvents, pH modifiers, ultraviolet light stabilizers, antioxidants, algaecides, antimicrobial agents, fragrances, buffers, hydrotropes, antifouling agents, enzymes, suspending agents, emulsifying agents, antifoaming agents, organic solvents, VOC-free solvents, solubilizers, and/or water-miscible solvents.

In another preferred embodiment, the antimicrobial composition is in liquid, solid, or gel form, preferably the composition is a liquid.

In one embodiment of the invention, the antimicrobial product comprises the antimicrobial composition according to the embodiments described.

Another embodiment of the present application discloses a method for killing or inhibiting the growth of bacteria and fungi in selected consumer products from the group consisting of personal care or cosmetic products, toilet products, oral care products, skin care products, hair care products, household and cleaning products, soap and bath products, industrial and institutional cleaning products, disinfectant products, wound care products, sanitary products, agricultural compositions, textile products, coating products, and laundry products that are susceptible to the growth of microorganisms, comprising the incorporation of approximately 0.01% by weight to 5.0% by weight of the antimicrobial composition described above into the desired products.

In another object of the invention, reference is made to the process of obtaining the antimicrobial composition, which comprises the following steps:
a) Add the antimicrobial agent phenoxyethanol and the solvent agent glycerol, stir the mixture until completely homogenized and incorporate the antibacterial 1,2-hexanediol;
b) Stir the mixture from step a) until homogenized;
c) Heat the mixture with stirring, for example, to 50-55° C.;
d) Lower the temperature, for example, to 30° C. and filter;
e) Mix the preservatives, acetic acid or citric acid or lactic acid with the product obtained in step d) until complete homogenization.

Due to its chemical nature, the invention exhibited high compatibility with different types of surfactants in personal hygiene formulations.

In another modality of the obtaining process and in order to improve the reaction performance, propylene glycol can be added as a formulation aid.

### Advantages of the Invention

The antimicrobial product of the present invention can be used at low concentrations, is soluble in water and polar solvents, is compatible with anionic surfactants, has a broad spectrum of activity, is stable at low temperatures, and is easy to extract.

The antimicrobial composition according to the present invention exhibited effectiveness in a broad spectrum that includes the following microorganisms: Pseudomonas aeruginosa, Escherichia coli, Staphylococcus aureus, Candida albicans, Aspergillus brasilensis, Salmonella typhimurium and Enterococcus hirae, giving complete coverage of effectiveness for some gram-positive, gram-negative microorganisms, yeasts and molds to develop antimicrobial products.

The advantages over other antimicrobial products are that it has both antibacterial and preservative properties, with ingredients approved for use in cosmetic products. It can act as a stabilizer with multifunctional properties (effective antimicrobial, preservative, and regulator).

The antimicrobial composition is a colorless, low-odor liquid that can be used for the manufacture of cosmetic and toiletry products.

The antimicrobial composition claimed in the present invention is highly soluble, safe, low risk, easy to use and handle.

It can serve as a solvent, a vehicle for other ingredients (e.g., fragrances, colorants, etc.) during the production of cosmetics or toiletries.

### EXAMPLES

During the development of the antimicrobial composition of the present invention, a product was sought that was broad-spectrum against gram-positive and gram-negative bacteria, molds and yeasts at low concentrations, and whose bactericidal activity among its compounds would facilitate its incorporation into cosmetic, surgical and hygiene formulations.

It is understood that the following examples and embodiments described in this document are not limiting and should be understood for illustrative purposes only, and that various modifications or changes in light of them will be suggestive to those skilled in the art and should be included within the spirit and scope of this application and the scope of the claims attached thereto.

In one embodiment of the invention, the formulation was prepared as follows:
a. Add 5% of the antimicrobial agent phenoxyethanol and 0.5% of the solvent agent glycerol, stir the mixture until completely homogenized and incorporate 25% of the antibacterial 1,2-hexanediol.
b. Stir the mixture from step a) until homogenized;
c. Heat the mixture with stirring, for example, to 50-55° C.;
d. Lower the temperature, for example, to 30° C. and filter;
e. Mix lactic acid in a proportion of 69.5% with the product obtained in step d) until complete homogenization.

In particular, in a preferred embodiment, the qualitative and quantitative composition and bactericidal activity of the antimicrobial composition claimed in the present invention are exemplified and illustrated in more detail by the following examples of microbicidal activity and in the following formulation. It should be noted that, in the formulation example, lactic acid may be substituted by the same amounts of any other active ingredient claimed as component (c).

### Example of Formulation

The following formulation should not be understood as limiting or restrictive of the claimed subject matter, since different modalities of the same with different formulation aids may be presented and developed from the same teachings described in the description of this application.

TABLE 1
Antimicrobial composition according to the invention

| | Initial | |
|---|---|---|
| Antimicrobial | weight in | % by |
| composition | grams | weight |
| Phenoxyethanol | 100 | 5% |
| 1,2-hexanediol | 500 | 25% |
| lactic acid | 1390 | 69.5% |
| Glycerol or | 10 | 0.5% |
| Propylene Glycol | | |
| Total | 2000 | 100 |

The presence of glycerol or propylene glycol in the above formulation should be understood as excipients which provide stability to the formulation resulting in a product with a translucent appearance, which does not allow clouding, and which additionally has a stable physicochemical appearance over time.

### Examples of Antimicrobial Activity

An antibacterial household soap was prepared with a 1.0% dosage of the antibacterial composition of the present invention, with an anionic charge where an effectiveness test was performed under the Method of analysis: AOAC Edition 21st Chapter 6 Germicidal action and disinfectant detergent (European Technical Standard). The results obtained are presented in Table 2.

TABLE 2
Antibacterial and fungicidal effectiveness of the antibacterial soap
containing the antimicrobial composition of the present invention

| | 1% Antibacterial soap | | | | |
|---|---|---|---|---|---|
| | Antibacterial composition of the present invention. | | | | |
| Results | | | | Percentage | |
| Microorganisms | Contact time | | | Reduction | Inter- |
| Evaluated | 30 sec | 1 min | 2 min | % | pretation |
| Escherichia coli | ≥99.9% | ≥99.9% | ≥99.9% | 99.9 | Reduction in |
| | | | | | viable counts |
| Pseudomonas | ≥99.9% | ≥99.9% | ≥99.9% | 99.9 | Reduction in |
| aeruginosa | | | | | viable counts |
| Salmonella | ≥99.9% | ≥99.9% | ≥99.9% | 99.9 | Reduction in |
| typhimurium | | | | | viable counts |
| Staphylococcus | ≥99.9% | ≥99.9% | ≥99.9% | 99.9 | Reduction in |
| aureus | | | | | viable counts |
| Candida albicans | ≥99.9% | ≥99.9% | ≥99.9% | 99.9 | Reduction in |
| | | | | | viable counts |
| Aspergillus | ≥99.9% | ≥99.9% | ≥99.9% | 99.9 | Reduction in |
| brasiliensis | | | | | viable counts |

As shown in Table 2, the test performed showed an antibacterial and fungicidal effectiveness ≥99.9% against a group of gram-positive and gram-negative bacteria, yeasts and molds from a contact time of 30 seconds, resulting in a total reduction in the viable counts of the microorganisms.

An evaluation of the product's bactericidal activity was also performed using a growth assay in a detergent for disinfecting surgical equipment and surgical handwashing, with a 1.0% dosage of the antibacterial composition of the present invention, with an anionic charge. The effectiveness test was conducted according to Colombian Technical Standard NTC 5732, Chemical Disinfectants and Antiseptics. This quantitative suspension assay is performed to evaluate the bactericidal activity of products for rubbing and hygienic and surgical handwashing, and the results obtained are presented in Table 3.

TABLE 3
Effectiveness of the bactericidal composition of a detergent for
disinfecting surgical equipment and surgical hand washing containing
the antimicrobial composition of the present invention

| | Detergent containing the antibacterial | | | |
|---|---|---|---|---|
| | composition of the invention at 1% | | | |
| | Reduction of | | Percentage | |
| | viability (UFC/ml)/ | | Reduction | |
| Results | Log 5 minutes | | 5 minutes of | |
| Microorganisms | of contact time | | contact time | Inter- |
| Evaluated | (CFU/ml) | Log | % | pretation |
| Escherichia coli | 6.5.E+05 | 5.8 | 99.99 | Reduction in |
| | | | | viable counts |
| Pseudomonas | 1.7.E+05 | 5.2 | 99.99 | Reduction in |
| aeruginosa | | | | viable counts |
| Enterococcus hirae | 2.0.E+04 | 4.3 | 99.99 | Reduction in |
| | | | | viable counts |
| Staphylococcus | 2.4.E+05 | 5.4 | 99.99 | Reduction in |
| aureus | | | | viable counts |

As shown in Table 3, the effectiveness of the antibacterial composition of the invention ata dose of 1% based on product against a group of gram positive and negative bacteria, presents a bactericidal action of 99.99% from 2 minutes of exposure for disinfectant products for surgical hand washing that demonstrate a reduction of 105 of viable counts of CFU of the microorganisms evaluated in a period of time from 5 minutes.

A bactericidal evaluation of the product was also carried out by means of a growth assay of a surgical soap with the antibacterial composition of the invention at 1% and comparing it with an active ingredient frequently used for that application of surgical soap which is 5% chlorhexidine gluconate. The results obtained are presented in Table 4.

TABLE 4
Effectiveness of a surgical soap containing the bactericidal composition
of the present invention vs. 5% chlorhexidine gluconate surgical soap

| | Surgical soap | | | |
|---|---|---|---|---|
| | 1% Antibacterial composition of the invention | | | |
| | Viability | | Percentage | |
| | reduction (CFU/ml)/ | | Reduction | |
| Results | Log Contact time | | Contact time | |
| Microorganisms | 5 minutes | | 5 minutes | Inter- |
| Evaluated | (CFU/ml) | Log | % | pretation |
| Escherichia coli | 6.5.E+05 | 5.8 | 99.99 | Reduction of |
| | | | | viable count |
| Pseudomonas | 1.7.E+05 | 5.2 | 99.99 | Reduction of |
| aeruginosa | | | | viable count |
| Enterococcus hirae | 2.0.E+04 | 4.3 | 99.99 | Reduction of |
| | | | | viable count |
| Staphylococcus | 2.4.E+05 | 5.4 | 99.99 | Count reduction |
| aureus | | | | viable |
| | Surgical soap | | | |
| | 5% Chlorhexidine Gluconate 20% | | | |
| | Viability | | Percentage | |
| | reduction (CFU/ml)/ | | Reduction | |
| Results | Log Contact time | | Contact time | |
| Microorganisms | 5 minutes | | 5 minutes | Inter- |
| Evaluated | (CFU/ml) | Log | % | pretation |
| Escherichia coli | 6.5.E+05 | 5.8 | 99.99 | Reduction of |
| | | | | viable count |
| Pseudomonas | 1.7.E+05 | 5.2 | 99.99 | Reduction of |
| aeruginosa | | | | viable count |
| Enterococcus hirae | 2.0.E+04 | 4.3 | 99.99 | Reduction of |
| | | | | viable count |
| Staphylococcus | 2.4.E+05 | 5.4 | 99.99 | Count reduction |
| aureus | | | | viable |

As shown in Table 4, the antimicrobial composition at a 1% concentration exhibited 99.99% bactericidal activity after 5 minutes of exposure for surgical handwashing products, demonstrating a 10° reduction in viable colony-forming units (CFU) of the evaluated microorganisms within 5 minutes. Furthermore, the claimed composition was found to be effective at lower concentrations compared to known compositions at higher concentrations.

A bactericidal evaluation of the product was also performed using a growth assay on an antibacterial disinfectant for household cleaning, where the antibacterial of the invention was dosed at 1%, and the disinfectant test was carried out under the standard NTC 5150 Antiseptic and chemical disinfectants. Bactericidal activity. NTC 5329 Antiseptic and chemical disinfectant. Fungicidal activity, the results obtained are presented in Table 5.

TABLE 5
Effectiveness of an antibacterial disinfectant for household cleaning
containing the bactericidal composition of the present invention

| | | tested action | tested action |
|---|---|---|---|
| | | time clean | time clean |
| | | charge cationic | charge cationic |
| | | charge disinfectant | charge disinfectant |
| | | 1.0% of the | 1.0% of the |
| | | antibacterial | antibacterial |
| | | composition of | composition of |
| | Positive | the invention | the invention |
| Microorganisms | Control | 2 min | 5 min |
| Evaluated | Count | % Effectiveness | % Effectiveness |
| Escherichia coli | 9.E+07 | 99.99 | 99.99 |
| Staphylococcus | 2.E+08 | 99.99 | 99.99 |
| aureus | | | |
| Pseudomonas | 8.E+08 | 99.99 | 99.99 |
| aeruginosa | | | |
| Candida albicans | 1.E+07 | 99.99 | 99.99 |
| | | 99.99 | 99.99 |

As shown in Table 5, the test performed showed a disinfectant effectiveness of 99.99% from a contact time of 2 minutes for bacteria and yeast.

An additional test was also conducted using the antibacterial composition of the invention at 0.1% as a preservative agent. This test was performed using a 0.1% concentration of the antibacterial composition of the invention, according to ISO 11930, in which a shampoo was prepared, and the 0.1% antibacterial composition of the invention was added as a preservative. The results obtained are presented in Table 6.

TABLE 6
Preservative efficacy test with the antibacterial composition of the invention at 0.1%

| Shampoo With | Challenge Test | | | | | | | | Preservative |
|---|---|---|---|---|---|---|---|---|---|
| preservatives | 7 days | | 14 days | | 21 days | | 28 days | | qualification |
| having the | % Reduction | | | | | | | | according |
| antibacterial | Bacteria | Fungus | Bacteria | Fungus | Bacteria | Fungus | Bacteria | Fungus | to ISO |
| composition | | | | | | | | | 11930/CTFA |
| of the | | | | | | | | | criteria/ |
| invention at | | | | | | | | | Ph. Eur. 7 |
| 0.1% | 100 | 100 | 100 | 100 | 100 | 100 | 100 | 100 | Optimal |
| | | | | | | | | | preservative |
| | | | | | | | | | reduction |

As shown in Table 6, the formulation's rating as a preservative agent corresponds to optimal preservative reduction of bacteria and fungi within the evaluated product, which helps preserve the product for up to one year. This means that the antibacterial composition of this application offers an additional advantage as a preservative that can be added in the manufacture of cosmetic, surgical, and personal care products.

1. An antimicrobial composition characterized in that it comprises:
a) a first antimicrobial agent comprising an organic compound, preferably an alcohol
b) a second antimicrobial agent comprising an aliphatic alcohol, preferably alkanediols and combinations thereof and
c) a third antimicrobial agent comprising a carboxylic acid selected from acetic acid, citric acid, lactic acid and combinations thereof.

2. The antimicrobial composition according to claim 1 wherein the first antimicrobial agent is selected from phenoxypropanol, 2-phenylethanol, phenoxyethanol, phenethyl alcohol, benzyl carbinol, β-hydroxyethylbenzene, benzeneethanol and combinations thereof in an amount between 0.0001% and 70% by weight.

3. The antimicrobial composition according to claim 2, characterized in that the first antimicrobial agent is phenoxyethanol and is present in an amount between 0.5% and 10%, preferably between 2% and 8%, more preferably between 2% and 7%.

4. The antimicrobial composition according to claim 1 wherein the second antimicrobial agent is selected from 1,2-hexanediol, 1,2-pentanediol, 1,2-butanediol, 1,4-butanediol, 1,5-pentanediol, 1,6-hexanediol and combinations thereof in an amount between 0.5% and 60% by weight.

5. The antimicrobial composition according to claim 4, characterized in that the second antimicrobial agent is 1,2-hexanediol and is present in an amount between 15% and 35%, preferably between 15% and 30% and more preferably between 15% and 28%.

6. The antimicrobial composition according to claim 1, characterized in that the third antimicrobial agent is lactic acid in an amount between 15% and 75%, preferably between 30% and 75% and more preferably between 60% and 75%.

7. The antimicrobial composition according to claim 1, characterized in that the composition is in liquid, solid or gel form.

8. The antimicrobial composition according to claim 7, characterized in that the composition is a liquid.

9. An antimicrobial product characterized in that it comprises the antimicrobial composition according to claim 1.

10. The product of claim 9 characterized in that it is a cosmetic, surgical or toiletry product.
